(19) United States
(12) Patent Application Publication
(10) Pub. No.: US 2023/0008967 A1
(43) Pub. Date: Jan. 12, 2023

(54) METHODS OF COMMUNICATION IN TRAFFIC INTERSECTION MANAGEMENT

(71) Applicant: Telefonaktiebolaget LM Ericsson (publ), Stockholm (SE)

(72) Inventors: Edwin IUN, Ottawa (CA); John LUSZCZEK, Ottawa (CA); Victoria HAYASHI, Victoria (CA)

(21) Appl. No.: 17/778,876

(22) PCT Filed: May 26, 2020
(86) PCT No.: PCT/IB2020/054990

§ 371 Date: May 23, 2022

Related U.S. Application Data
(60) Provisional application No. 62/939,317, filed on Nov. 22, 2019.

(51) Int. Cl. G08G 1/087; G08G 1/01; G08G 1/0968

(52) U.S. Cl. CPC G08G 1/087; G08G 1/0112; G08G 1/096827; G08G 1/0141

(57) ABSTRACT

A vehicle computer for use in a vehicle. The vehicle computer includes at least one processor; an interface to a radio communications network; and a memory including software instructions configured to control the at least one processor to implement a method including steps of: receiving, from a traffic information hub in the radio communications network, intersection condition information regarding a next intersection along a route of the vehicle; and calculating route and navigation information based at least in part on the received intersection condition information. Also disclosed is a traffic information hub including: at least one processor; an interface to a data network; and a memory including software instructions configured to control the at least one processor to implement a method including steps of: receiving intersection condition information for each one of a plurality of traffic intersections; and receiving a query from a vehicle.

### TECHNICAL FIELD

The present disclosure relates to communications networks, and in particular to methods of communication in traffic intersection management.

### BACKGROUND

The automotive industry is evolving toward connected and autonomous vehicles that offer many benefits, such as improved safety, less traffic congestion, less environmental impacts and lower capital expenditure.

V2X communications as defined in 3GPP consists of four types: V2V, V2I, V2N and V2P. For many years, there has been a goal that vehicles should be able to communicate with not only other vehicles (V2V) but also with nearby infrastructure (V2I), Internet-based networks (V2N) and even pedestrians (V2P). Collectively these use cases have become known as vehicle-to-everything (V2X) connectivity.

In general vehicle-to-everything (V2X) communication allows a vehicle to communicate with other vehicles, pedestrians, road-side equipment, network equipment and the Internet. With V2X, critical information can be exchanged among vehicles to improve situation awareness and thus avoid accidents. Furthermore, V2X provides reliable access to the vast information available in the cloud. For example, real-time traffic, sensor and high-definition mapping data can be made available, which is useful not only for today's drivers but will be essential for navigating self-driving vehicles in the future.

### SUMMARY

An aspect of the present disclosure provides a method in a vehicle computer for use in a vehicle. The method comprises: receiving, from a traffic information hub in the radio communications network, intersection condition information regarding a next intersection along a route of the vehicle; and calculating route and navigation information based at least in part on the received intersection condition information.

In some embodiments, the intersection condition information may comprise information indicative of any one or more of:
a road condition;
a vehicular traffic condition;
a pedestrian traffic condition;
a weather condition; and
a traffic light status.

In some embodiments, a query is sent to the traffic information hub, the query identifying at least the next intersection along the route of the vehicle, the intersection condition information being received after sending the query.

Some embodiments may further comprise reporting vehicle status information to the traffic information hub, the vehicle status information including at least an identifier of the vehicle and sensor data indicative of a status of the vehicle.

Some embodiments may further comprise reporting vehicle status information to a vehicle status and detection server in the wireless communications network, the vehicle status information including at least an identifier of the vehicle and sensor data indicative of a status of the vehicle.

The sensor data may comprise any one or more of:
a current speed of the vehicle; and
a current direction of the vehicle;

In some embodiments, the vehicle status information may further include location information identifying a current location of the vehicle.

In some embodiments, the location information may comprise one of more identifiers indicative of a road on which the vehicle is located and a direction of travel of the vehicle.

In some embodiments, the location information may further comprise either one or both of an identifier of a waypoint associated with the road and a predetermined segment of the road.

In some embodiments, the location information may further comprise a distance between the vehicle and the next intersection.

In some embodiments, the route and navigation information may be calculated based on both the received intersection condition information and the vehicle status information.

In some embodiments, the vehicle status information may further comprise an indication of a priority of the vehicle.

In some embodiments, calculating route and navigation information may comprise calculating, in response to the received intersection condition information, any one or more of: a route change; a lane change; and a speed change.

In some embodiments, calculating a speed change may comprise calculating a speed profile for the vehicle between a current location of the vehicle and the next intersection.

In some embodiments, the intersection condition information may comprise an indication of congestion of the next intersection, and wherein calculating the speed profile for the vehicle comprises determining a speed profile that minimizes the congestion.

In some embodiments, the intersection condition information may comprise an indication of priority vehicle traffic, and wherein calculating the speed profile for the vehicle comprises determining a speed profile that minimizes a conflict between the vehicle and the priority vehicle traffic.

In some embodiments, the indication of priority vehicle traffic may comprise information indicative of an arrival time of the priority vehicle traffic at the next intersection, and wherein determining a speed profile that minimizes a conflict between the vehicle and the priority vehicle traffic comprises determining the speed profile such that the vehicle will arrive at the next intersection after the priority vehicle traffic.

A further aspect of the present disclosure provides a vehicle computer for use in a vehicle. The vehicle computer comprises: at least one processor; an interface to a radio communications network; and a memory including software instructions configured to control the at least one processor to implement the methods described above.

A still further aspect of the present disclosure provides a method in a traffic information hub of a communications network. The method comprises: receiving sensor data indicative of a condition of a traffic intersection; and sending corresponding intersection condition information for the traffic intersection to a vehicle.

In some embodiments the sensor data indicative of a condition of a traffic intersection may comprises sensor data indicative of any one or more of:
a road condition;
a vehicular traffic condition;
a pedestrian traffic condition;
a weather condition; and
a traffic light status.

In some embodiments, the intersection condition information may comprise one or more indicators that are derived from the sensor data.

Some embodiments may further comprise receiving respective sensor data indicative of a condition of a plurality of traffic intersections.

Some embodiment may further comprise receiving a query from the vehicle, the intersection condition information being sent to the vehicle responsive to the query.

In some embodiments, the query may include an identifier of a selected traffic intersection, and wherein sending the intersection condition information for the selected traffic intersection comprises sending intersection condition information associated with the identifier.

In some embodiments, the query may include a current location of the vehicle. Sending the intersection condition information for the selected traffic intersection may comprise: identifying a next intersection along a route of the vehicle, based at least in part on the current location of the vehicle; and sending the intersection condition information for the identified next intersection.

Some embodiment may further comprise receiving vehicle status information from the vehicle, the vehicle status information including at least an identifier of the vehicle and sensor data indicative of a status of the vehicle.

In some embodiments, the sensor data may comprise any one or more of: a current speed of the vehicle; and a current direction of the vehicle.

In some embodiments, the vehicle status information may further include information identifying a current location of the vehicle.

In some embodiments, the intersection condition information may comprise an indication of congestion of the next intersection.

In some embodiments, the indication of congestion may comprise a predicted congestion of the next intersection at an estimated time of arrival of the vehicle at the next intersection.

Some embodiments may further comprise controlling traffic control infrastructure associated with the next intersection to mitigate the congestion.

In some embodiments, the query may include an indication of a priority of the vehicle, and the method may further comprise controlling the next intersection to provide priority access to the vehicle based on the indication of priority of the vehicle.

In some embodiments, the method may further comprise instructing a second vehicle to adjust either one or both of its route and speed to minimize conflict with the vehicle.

A still further aspect of the present disclosure provides a traffic information hub in a radio communications network, the traffic information hub comprising: at least one processor; an interface to the radio communications network; and a memory including software instructions configured to control the at least one processor to implement a method as described above:

### BRIEF DESCRIPTION OF THE DRAWINGS

The accompanying drawing figures incorporated in and forming a part of this specification illustrate several aspects of the disclosure, and together with the description serve to explain principles of the disclosure.

FIG. 1 is a block diagram schematically illustrating a representative network in which embodiments of the present invention may be deployed;

FIGS. 2A and 2B are block diagrams schematically illustrating examples of a computing device usable in embodiments of the present invention;

FIG. 3 is a block diagram schematically illustrating an architecture of a representative network element virtualization usable in embodiments of the present invention;

FIG. 4 is a block diagram schematically illustrating communication links in an autonomous vehicle communication system;

FIG. 5 is a block diagram schematically illustrating an example autonomous vehicle communication system in accordance with a representative embodiment of the present invention;

FIG. 6 is a flow chart illustrating example operations of a vehicle computer in the example embodiment of FIG. 5

FIG. 7 is a flow chart illustrating example operations of a Traffic Information Hub in the example embodiment of FIG. 5

FIG. 8 is a flow chart illustrating example operations in the example embodiment of FIG. 5;

FIG. 9 is a block diagram schematically illustrating a second example autonomous vehicle communication system in accordance with a representative embodiment of the present invention;

### DETAILED DESCRIPTION

The embodiments set forth below represent information to enable those skilled in the art to practice the embodiments and illustrate the best mode of practicing the embodiments. Upon reading the following description in light of the accompanying figures, those skilled in the art will understand the concepts of the disclosure and will recognize applications of these concepts not particularly addressed herein. It should be understood that these concepts and applications fall within the scope of the disclosure.

At least some of the following abbreviations and terms may be used in this disclosure.
2D Two Dimensional
3G Third Generation Wireless Technology
3GPP Third Generation Partnership Project
4G Fourth Generation Wireless Technology
5G Fifth Generation Wireless Technology
5GC 5G Core
AAS Antenna Array System
AoA Angle of Arrival
AoD Angle of Departure
ASIC Application Specific Integrated Circuit
AV Autonomous Vehicle
BF Beamforming
BLER Block Error Rate
BW Beamwidth
CPU Central Processing Unit
CSI Channel State Information
CSMA/CA Carrier Sense Multiple Access/Collision Avoidance
dB Decibel
DCI Downlink Control Information
DFT Discrete Fourier Transform
DSP Digital Signal Processor
DSRC Dedicated Short Range Communications
E911 Enhanced 911, the number for requesting help in an emergency
eNB Enhanced or Evolved Node B
FIR Finite Impulse Response
FPGA Field Programmable Gate Array
gNB New Radio Base station
GPS Global Positioning System
ICC Information carrying Capacity
IIR Infinite Impulse Response
L0 Level 0: No Driving Automation
L1 Level 1: Driver Assistance
L2 Level 2: Partial Driving Automation
L3 Level 3: Conditional Driving Automation
L4 Level 4: High Driving Automation
L5 Level 5: Full Driving Automation
LPPa LTE Positioning Protocol A
LTE Long Term Evolution
MIMO Multiple Input Multiple Output
ML Machine Learning
MME Mobility Management Entity
MMSE Minimum Mean Square Error
ms millisecond
MTC Machine Type Communication
NR New Radio
OTT Over-the-Top
PBCH Physical Broadcast Channel
PDCCH Physical Downlink Control Channel
PDSCH Physical Downlink Shared Channel
P-GW Packet Data Network Gateway
RAM Random Access Memory
ROM Read Only Memory
RRC Radio Resource Control
RRH Remote Radio Head
SAE Society of Automotive Engineers
SCEF Service Capability Exposure Function
SINR Signal to Interference plus Noise Ratio
TBS Transmission Block Size
UE User Equipment
ULA Uniform Linear Array
URA Uniform Rectangular Array
V2I vehicle-to-Infrastructure
V2N vehicle-to-Network
V2 P vehicle-to-Pedestrian
V2V vehicle-to-vehicle
V2X vehicle-to-Everything
VRU Vulnerable Road User

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting (and/or receiving) signals to (and/or from) a radio access node. Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cell: As used herein, a “cell” is a combination of radio resources (such as, for example, antenna port allocation, time and frequency) that a wireless device may use to exchange radio signals with a radio access node, which may be referred to as a host node or a serving node of the cell. However, it is important to note that beams may be used instead of cells, particularly with respect to 5G NR. As such, it should be appreciated that the techniques described herein are equally applicable to both cells and beams.

Note that references in this disclosure to various technical standards (such as 3GPP TS 38.211 V15.1.0 (2018-03) and 3GPP TS 38.214 V15.1.0 (2018-03), for example) should be understood to refer to the specific version(s) of such standard(s) that was(were) current at the time the present application was filed, and may also refer to applicable counterparts and successors of such versions.

The description herein focuses on a 3GPP cellular communications system and, as such, 3GPP terminology or terminology similar to 3GPP terminology is oftentimes used. However, the concepts disclosed herein are not limited to a 3GPP system.

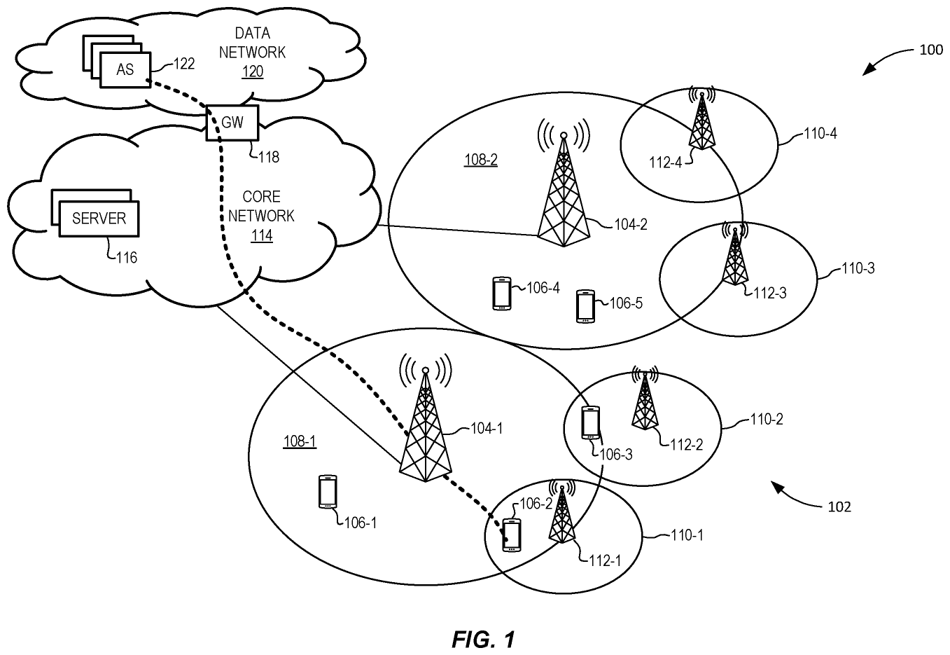

FIG. 1 illustrates one example of a cellular communications network 100 in which embodiments of the present disclosure may be implemented. In the embodiments described herein, the cellular communications network 100 is a Public Land Mobility Network (PLMN) conforming to one or more of the LTE, 3G, 4G and 5G NR standards, or their successors. In the illustrated example, the cellular communications network 100 includes a (Radio) Access Network ((R)AN) 102 comprising base stations 104-1 and 104-2 controlling radio communications with wireless devices 106-1, 106-2, 106-3, 106-4, 106-5 within corresponding macro cells 108-1 and 108-2. Each macro cell 108 may be defined by any suitable combination of geography, frequency, Radio Access Technology (RAT) and modulation scheme.

Base stations 104 can be any type of network access device capable of establishing radio connection(s) with one or more wireless devices 106 within a respective coverage area of the base station 104 or low power node 112, and further configured to forward subscriber traffic between the core network 114 and the one or more wireless devices 106. An important feature of a base station 104 is that it is configured with both a radio interface configured to send and receive radio signals to and from a wireless device 106, and a network interface configured to exchange electronic and/or optical signals with the core network 114. Examples of base stations 104 and low power nodes 112 include: Evolved Node B (eNB) systems (known, for example, in the 3GPP standards): WiFi access points (known, for example from IEEE 802.11 standards) or the like. In some contexts, a base station 104 may be referred to as an access point (AP) regardless of the Radio Access Technology (RAT) that it supports.

The illustrated (R)AN 102 also includes small cells 110-1 through 110-4, within which radio communication can be controlled by corresponding low power nodes 112-1 through 112-4. As with the macro cells 108, each small cell may be defined by any suitable combination of geography, frequency, Radio Access Technology (RAT) and modulation scheme. As with the base stations 104, a low power node 112 can be any type of network access device capable of establishing radio connection(s) with one or more wireless devices 106 within a respective coverage area of the low power node 112, and further configured to forward subscriber traffic between the core network 114 and the one or more wireless devices 106. An important feature of a low power node 112 is that it is configured with both a radio interface configured to send and receive radio signals to and from a wireless device 106, and a network facing interface configured to exchange electronic and/or optical signals with the core network 114. In some embodiments, a low power node 112 may be connected to the core network 114 by a direct connection, such as an optical cable. In other embodiments, a low power node 112 may be connected to the core network 114 by an indirect connection, such as via a radio or optical fiber link to a base station 104. Examples of low power nodes 112 include: Remote Radio Heads (RRHs) connected to a base station or a network router (not shown): WiFi access points or the like. In some contexts, a low power node 112 may be referred to as an access point (AP) regardless of the specific Radio Access Technology (RAT) that it supports.

Notably, while not illustrated, a particular small cell 110 may alternatively be controlled by a base station 104, for example using a beam-forming technique. In such cases, the particular small cell 110 will not be associated with a respective low power node 112 per se. Rather, the particular small cell 110 will be associated with a respective set of parameters implemented in the base station 104. In this disclosure, the term “cell” is used to refer to a defined combination of parameters (such as geography, frequency, Radio Access Technology (RAT), modulation scheme, identifiers and the like) that can be used by a wireless device 106 to access communication services of the network 100. The term “cell” does not imply any particular parameter values, or any particular physical configuration of devices needed to enable a wireless device 106 to access those communication services.

Wireless devices 106 can be any type of device capable of sending and receiving radio signals to and from a base station 104 and/or low power node 112. Examples of wireless device 106 include cellular phones, Personal Data Assistants (PDAs), mobile computers, Internet of Things (IoT) devices, electronic devices, autonomous vehicle controllers, and the like. In some contexts, a wireless device 106 may be referred to as a User Equipment (UE) or a mobile device or a modem.

In some embodiments, the macro cells 108-1 and 108-2 may overlap each other, and may also overlap one or more small cells 110. For example, a particular macro cell 108-1 may be one macro cell 108 among a plurality of macro cells covering a common geographical region and having a common RAT and modulation scheme, but using respective different frequencies and/or AP identifiers. In such cases, a wireless device 106 located within a region covered by two or more overlapping cells 108, 112 may send and receive radio signals to and from each of the corresponding base stations 104 and/or low power nodes 112.

In the illustrated example, the (R)AN 102 is connected to a Core Network (CN) 114, which may also be referred to as Evolved Core Network (ECN) or Evolved Packet Core (EPC) or 5G Core (5GC). The CN 114 includes (or, equivalently, is connected to) one or more servers 116 configured to provide networking services such as, for example, Network Functions (NFs) described in 3GPP TS 23.501 V15.2.0 (2018-06) “System Architecture for the 5G System” and its successors. The CN 114 also includes one or more gateway (GVV) nodes 118 configured to connect the CN 114 to a packet data network (DN) 120 such as, for example, the internet. A gateway node 118 may be referred to as a packet gateway (PGVV) and/or a serving gateway (SGVV). The DN 120 may provide communications services to support end-to-end communications between wireless devices 106 and one or more application servers (ASs) 122 configured to exchange data packet flows with the wireless devices 106 via the CN 114 and (R)AN 102. In some contexts, an application server (AS) 122 may also be referred to as a host server.

In some contexts, an end-to-end signal path between an AS 122 and one or more wireless devices 106 may be referred to as an Over-The-Top (OTT) connection. Similarly, a communication service that employs signal transmission between an AS 122 and one or more wireless devices 106 may be referred to as an OTT service.

It should be appreciated that the separation between the CN 114 and the DN 120 can be purely logical, in order to simplify understanding of their respective roles. In particular, the CN 114 is primarily focused on providing wireless device access services and supporting wireless device mobility. On the other hand, the DN 120 is primarily focused on providing end-to-end communications, particularly across network domains. However, it will be appreciated that both the CN 114 and the DN 120 can be implemented on common physical network infrastructure, if desired.

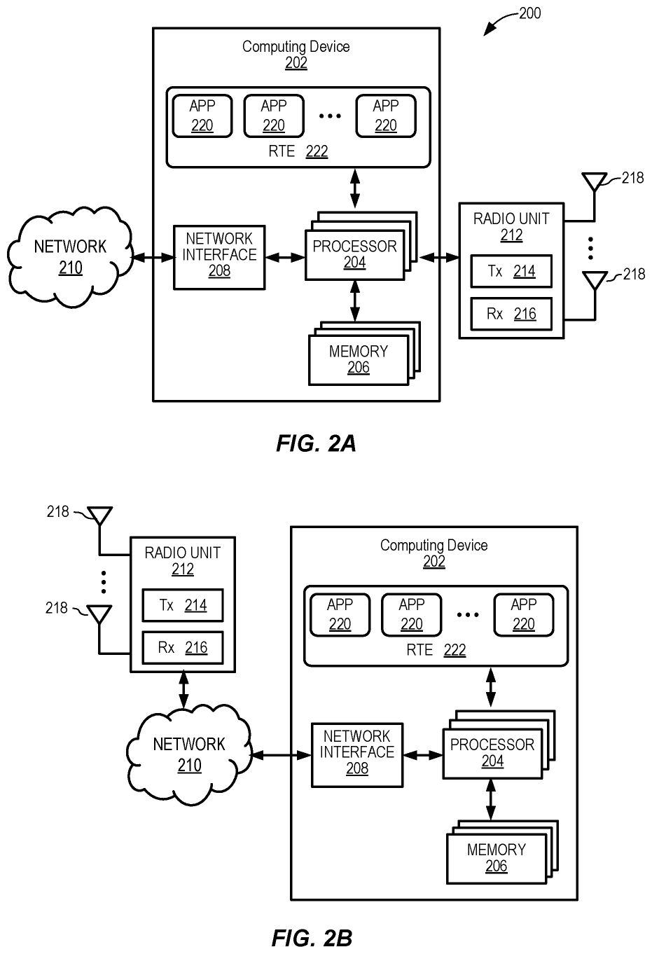

FIGS. 2A and 2B are block diagrams schematically illustrating a communications system 200 including a computing device 202 usable in embodiments of the present invention. In various embodiments, any or all of the base stations 104 or 112, wireless devices 106, core network servers 116 or gateways 118 and data network servers 122 may be implemented using systems and principles in accordance with the computing device 202. It may also be appreciated that any or all of the elements of the network 100 may be virtualized using techniques known in the art or developed in the future, in which case the functions of any or all the base stations 104 or 112, core network servers 116 or gateways 118, and/or any or all network functions may be implemented by suitable software executing within a computing device 202 or within a data center (not shown) composed of multiple computing devices 202.

In the example of FIG. 2A, the communications system 200 generally includes computing device 202 connected to one or more networks 210 and one or more radio units 212. The computing device 202 includes one or more processors 204, a memory 206, one or more network interfaces 208. The processors 204 may be provided as any suitable combination of Central Processing Units (CPUs), Application Specific Integrated Circuits (ASICs), Field Programmable Gate Arrays (FPGAs), or the like. Similarly, the memory 206 may be provided as any suitable combination of Random Access Memory (RAM), Read Only Memory (ROM) and mass storage technologies such as magnetic or optical disc storage or the like. The network interfaces 208 enable signaling between the computing device 200 and the networks 210, such as the Core Network 114, the data network 120, or a private domain network such as a data center (not shown).

Each radio unit 212 typically includes at least one transmitter (Tx) 214 and at least one receiver (Rx) 216 coupled to one or more antennas 218. In the example of FIG. 2A, the radio unit(s) 212 is(are) shown as being external to the computing device 202 and connected to the computing device 202 via a suitable physical connection (such as a copper cable or an optical cable). In the example of FIG. 2B, the radio unit(s) 212 is(are) shown as being connected to computing device 202 via a network 210 and a network interface 208. In still other embodiments, the radio unit(s) 212 and optionally also the antenna(s) 218 may be integrated together with the computing device 202.

The one or more processors 204 operate to provide functions of the computing device 202. Typically, these function(s) are implemented as software applications (APPs) 220 or modules that are stored in the memory 206, for example, and executed by the one or more processors 204. In some embodiments, one or more software applications or modules 220 may execute within a secure run-time environment (RTE) 222 maintained by an operating system (not shown) of the computing device 202.

It may be appreciated that specific embodiments may exclude one or more of the elements illustrated in FIGS. 2A and 2B. For example, a computing device 202 configured to implement a wireless device 106 may incorporate one or more processors 204, a memory 206, and one or more radio units 212, but may exclude a network interface 208. Conversely, a computing device 202 configured to implement a server 116 or 122 may include one or more processors 204, a memory 206, and one or more network interfaces 208, but may exclude radio units 212. A computing device 202 configured to implement a base station 104 or 112, on the other hand, will normally include one or more processors 204, a memory 206, and both radio units 212 and network interfaces 208.

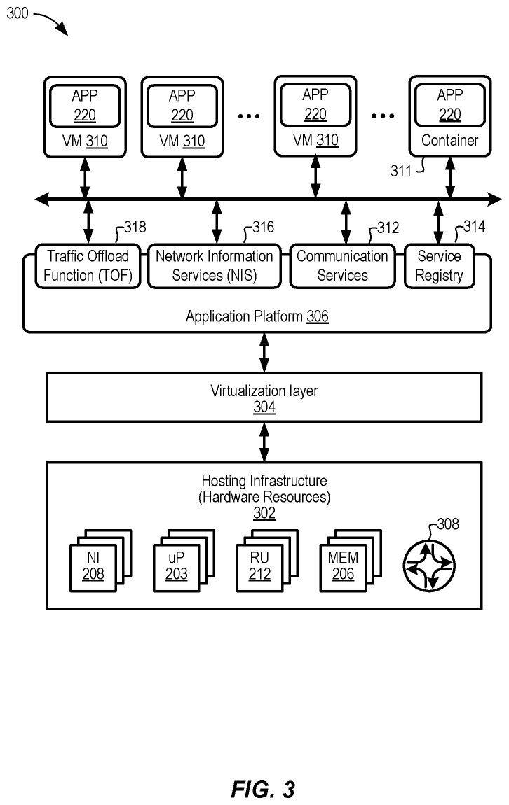

FIG. 3 is a block diagram schematically illustrating an example architecture for network element virtualization usable in embodiments of the present invention. It is contemplated that the network elements may be physically implemented using one or more computers, data storage devices and routers (any or all of which may be constructed in accordance with the system 200 described above with reference to FIG. 2) interconnected together and executing suitable software to perform its intended functions. Those of ordinary skill will recognize that there are many suitable combinations of hardware and software that may be used for this purpose, which are either known in the art or may be developed in the future. For this reason, a figure showing physical hardware components and connections is not included herein.

As maybe seen in FIG. 3, the illustrated architecture 300 generally comprises hosting infrastructure 302, a virtualization layer 304 and an application platform services layer 306. The hosting infrastructure 302 comprises physical hardware resources provided by the infrastructure on which the architecture 300 is being implemented. These physical hardware resources may include any or all of the processors 204, memory 206, network interfaces 208 and radio units 212 described above with reference to FIG. 2, and may also include traffic forwarding and routing hardware 308. The virtualization layer 304 presents an abstraction of the hardware resources 302 to the application platform services layer 306. The specific details of this abstraction will depend on the requirements of the applications 220 being hosted by the application platform services layer 306. Thus, for example, an APP 220 that provides traffic forwarding functions (for example as part of a User Plane Function, UPF) may be presented with an abstraction of the hardware resources 306 (e.g. processor(s) 204, memory 206 and traffic forwarding hardware 308) that simplifies the implementation of traffic forwarding policies. Similarly, an application that provides data storage functions (for example implementing a User Data Manager, UDM and/or a User Data Repository, UDR) may be presented with an abstraction of the hardware resources 306 (e.g. processor(s) 204 and memory 206) that facilitates the storage and retrieval of data (for example using Lightweight Directory Access Protocol—LDAP).

The application platform 306 provides the capabilities for hosting applications. In some embodiments, the application platform 306 supports a flexible and efficient multi-tenancy run-time and hosting environment for applications 220 by providing Infrastructure as a Service (IaaS) facilities. In operation, the application platform 306 may provide a security and resource “sandbox” for each application 220 being hosted by the platform 306. Each “sandbox” may be implemented as a Virtual Machine (VM) image 310 that may include an appropriate operating system and controlled access to (virtualized) hardware resources 302. Alternatively, each “sandbox” may be implemented as a container 311 that may include appropriate virtual memory and controlled access to host operating system and (virtualized) hardware resources 302. The application platform 306 may also provide a set of middleware application services and infrastructure services to the applications 220 hosted on the application platform 306, as will be described in greater detail below.

Applications 220 from vendors, service providers, and third-parties may be deployed and executed within a respective Virtual Machine 310. For example, PCF 220 may be implemented by means of one or more applications 220 hosted on the application platform 306 as described above. Communication between applications 220 and services of the application platform 306 may conveniently be designed according to the principles of Service-Oriented Architecture (SOA) known in the art.

Communication services 312 may allow applications 220 to communicate with the application platform 306 (through pre-defined Application Programming Interfaces (APIs) for example) and with each other (for example through a service-specific API).

A service registry 314 may provide visibility of the services available on the server. In addition, the service registry 314 may present service availability (e.g. status of the service) together with the related interfaces and versions. This may be used by applications 220 to discover and locate the end-points for the services they require, and to publish their own service end-point for other applications to use.

Network Information Services (NIS) 316 may provide applications 220 with low-level network information pertaining to a network service instance or one or more PDU sessions, for example. For example, the information provided by NIS 316 may be used by an application 220 to calculate and present relevant data (such as: cell-ID, location of the subscriber, cell load and throughput guidance) to network functions such as a Session Management Function (SMF), an Access and Mobility Function (AMF) and a Policy Control Function (PCF), any or all of which may themselves to implemented by applications 220 executing in respective VMs 310.

A Traffic Off-Load Function (TOF) service 318 may prioritize traffic, and route selected, policy-based, data streams to and from applications 220.

As noted above, vehicle-to-everything (V2X) communication allows a vehicle to communicate with other vehicles, pedestrians, road-side equipment, network equipment and the Internet. With V2X, critical information can be exchanged among vehicles to improve situation awareness and thus avoid accidents. Furthermore, V2X provides reliable access to the vast information available in the cloud. For example, real-time traffic, sensor and high-definition mapping data can be made available, which is useful not only for today's drivers but will be essential for navigating self-driving vehicles in the future.

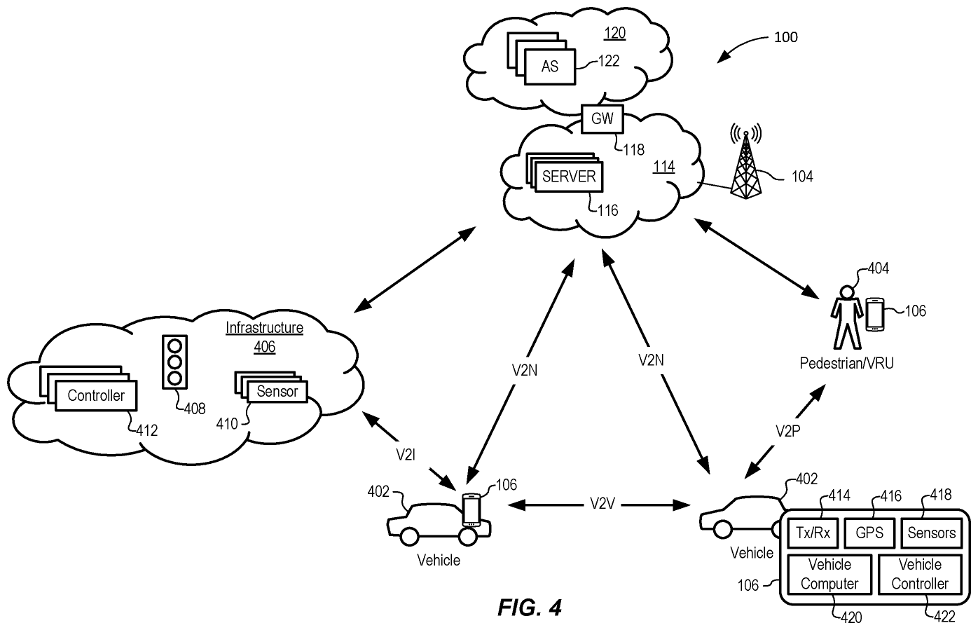

FIG. 4 is a block diagram schematically illustrating V2X communications in an example cellular network environment including a cellular communications network 100, vehicles 402, one or more pedestrians 404, and a traffic control infrastructure 406 which may include traffic lights 408, sensors 410 and controllers 412, any or all of which may be implemented using the techniques described above with reference to FIGS. 2 and 3. In the example of FIG. 4, core network servers 116 may be configured to implement a vehicle location detection function, for example, while application servers 122 may, for example, be configured to implement vehicle status and location tracking functions, as well as traffic information server functions. As may be seen in FIG. 4, V2X communication is typically considered to encompass vehicle-to-Infrastructure (V2I) communications between a vehicle 402 and the traffic control infrastructure 406; vehicle-to-Network (V2N) communications between a vehicle 402 and the communications network 100; vehicle-to-vehicle (V2V) communications between a vehicle 402 and another vehicle 402; and vehicle-to-Pedestrian (V2P) communications between a vehicle 402 and a pedestrian 404 (or, more typically, a wireless communication device 106 associated with the pedestrian 404). In order to enable V2X communication, each vehicle 402 may be provided with user equipment 106 which may include any one or more of: a cellular modem or transceiver 414; a GPS receiver 416; on-board sensors 418 such as vehicle status and collision avoidance sensors, for example; a vehicle computer 420; and vehicle controller 422, any or all of which may be implemented using the techniques described above with reference to FIGS. 2 and 3. Example on-board sensors 418 may include any combination of sensors and/or signal processing circuitry configured to detect any one or more of: current vehicle speed, current vehicle location, current vehicle direction of travel, current vehicle health and/or operating parameters, local road condition (e.g. dry, wet, ice etc.), and local traffic congestion.

The following list shows the candidate technologies which have been considered for V2X communication. Some of these candidate technologies have been rejected due to considerations of at least some of Latency, Coverage, Cost, Security and Privacy.
3G [rejected]
802.11 a/b/g/n . . . Wi-Fi [rejected]
Dedicated Short Range Communications (DSRC) [limited coverage in dense environment]
Satellite [rejected]
Short range radio such as Bluetooth, ZigBee & Others [rejected]
4G/LTE [good but latency is a concern]
5G [good]

The performance of the V2X network is most important for applications which require low latency and high reliability. DSRC uses CSMA/CA to achieve collision avoidance and the ability for multi-user access. With fewer vehicles, DSRC has lower latency and higher reliability, but its performance degrades in a dense vehicle environment.

In the future, 5G networks will provide a communication delay of less than 1 ms while providing a stability of 99.999%, so they will be able to support automatic-driving-oriented V2X services. For this reason, the present disclosure concentrates on the use of 5G networks, it being understood that alternative network technologies available now or in the future may be used for automatic-driving-oriented V2X services.

In 2014, the Society of Automobile Engineers (SAE) International published a classification system of six different levels based on the amount of driver intervention and attentiveness required. In 2016, SAE updated this classification to J3016_201609.

These levels are sometimes referred as L0 to L5, and have been adopted by the U.S. Department of Transportation. A description of levels L0-L5 is provided below.
L0: Level 0 (No Automation): Most vehicles on the road today are Level 0: manually controlled. A human driver provides the “dynamic driving task” although there may be systems in place to help the driver.
L1: Level 1 (Driver Assistance): This is the lowest level of automation. The vehicle features a single automated system for driver assistance, such as steering or accelerating (e.g. cruise control).
L2: Level 2 (Partial Automation): The vehicle takes control of steering, braking and accelerating. However, a human driver must sit in the driver's seat and be ready to take control of the vehicle at any time.
L3: Level 3 (Conditional Automation): The driver can safely turn their attention away from the driving tasks. The vehicles have “environmental detection” capabilities and they will handle situations themselves. The driver must remain alert and ready to take control if the system is unable to execute the task.
L4: Level 4 (High Automation): The key difference between Level 3 and Level 4 automation is that Level 4 vehicles can intervene if things go wrong or there is a system failure. In this sense, these vehicles do not require human interaction in most circumstances. However, a human still has the option to manually override.
L5: Level 5 (Full Automation): Level 5 vehicles do not require the attention of a human driver—the “dynamic driving task” is eliminated. Level 5 vehicles may not even have a steering wheel or acceleration/braking pedals. No human driver intervention is required at all. An example would be a robotic taxi.

The following key challenges were listed by a North American municipality, which may be used as a guideline for general requirements to consider in any autonomous vehicle deployment:
AV operations in inclement weather such as snow, ice, fog, and high winds
Development of systems that pinpoint the location of hidden objects (such as seeing around corners to spot moving people or objects)
Cybersecurity—AVs, smart infrastructure, and the Internet of Things
Interoperability, the ability of computer systems or software to exchange and make use of AV-generated data
Communication: V2X—vehicle-to-vehicle, vehicle-to-Infrastructure (city), vehicle-to-Network (DSRC/GPS/4G/5G)
Data: Collection and usage—data (from both sites) and analytical tools will be available to companies and researchers to accelerate AV innovation

A common consideration is Traffic Safety. Safety of both the driver and the Public is a priority. Certain precautions need to be met so that an AV deployment is as safe to use as possible. For example, if the connection to the network should fail, an autonomous vehicle must still be able to function safely. Also in the event of a collision or other type of accident, the AV will need to determine how best to function with the driver's safety in mind.

Currently, L4/L5 autonomous vehicles are in their infancy. Current implementations are mostly based on DSRC technology, which suffers from poor scalability due to signal collisions and it is therefore limited to test sites. Cellular technology is a well-accepted enabler for mass deployment of autonomous vehicle in public. However, a strategy for end-to-end Communication Infrastructure is lacking. This disclosure is aimed to address this gap.

Accordingly, systems and methods are disclosed herein that provide an end-to-end framework of Communication architecture so that a Traffic Intersection Management used by an autonomous vehicle is realized. The disclosed architecture may lead an autonomous vehicle to safely cross any intersection in all weather conditions, and may allow a closed loop tuning of traffic infrastructure equipment to combat congestion and to accommodate emergency accident handling.

This disclosure also explores benefits of deploying a cellular system for Traffic Intersection Management and autonomous vehicle control, especially in a 5G environment. Some embodiments aim to capture new use cases that have not previously been considered in research or deployment. Some embodiments do not require the development of new equipment, but instead may redefine the usage of known devices to address at least some of the following topics.
[Cellular in Autonomous Vehicle] How to use cellular technology especially 5G in public rollout of autonomous vehicle ecosystem. The legacy DSRC is not feasible in dense population area. The benefit of 5G NR low latency is also discussed.
[Severe Weather Considerations] Previous autonomous vehicle research has been focused on operations in warm temperate climate regions such as Southern California. This disclosure addresses a solution to address severe weather conditions such as, for example: a snow blizzard and icy road conditions; direct sunlight or glare that interferes with visual detection of objects; and objects (such as transport vehicles) that block line-of-sight detection of objects.
[Traffic Volume Prediction] This disclosure proposes a new usage of traffic data in modelling traffic flow. Also, the concept of handover and tracking area applied in prediction techniques such as Machine Learning is described to project the traffic volume at any intersection being managed.
[Cost Reduction to Infrastructure] This disclosure includes the tracking location of a vehicle; therefore, which may eliminate the need for traffic infrastructure such as toll highway transponders installed in the vehicle or at toll highway entrances

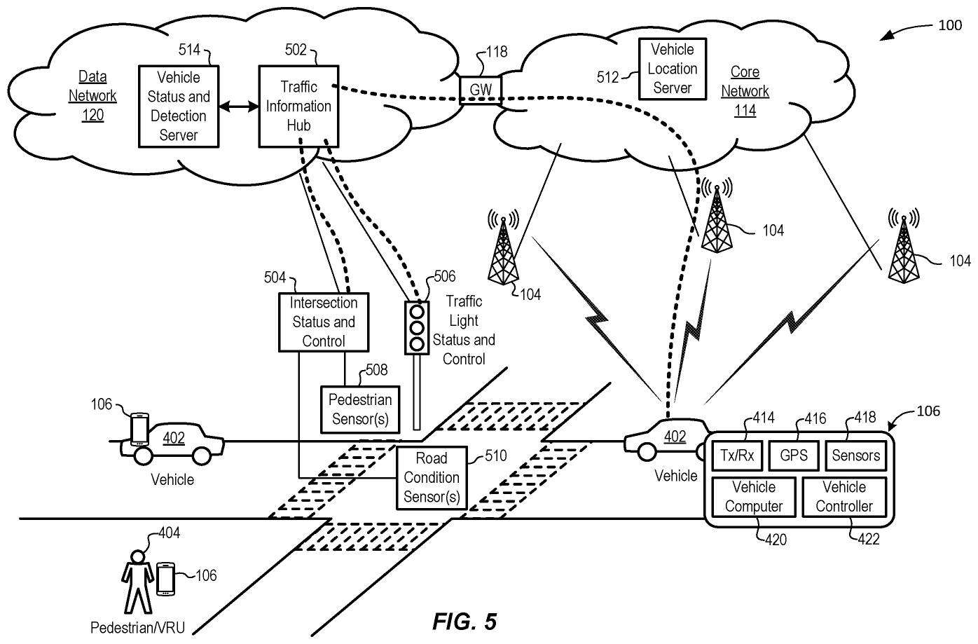

FIG. 5 illustrates representative interactions between elements in an example intersection management system. In the illustrated example, the intersection management system includes a traffic information hub 502 which may be implemented in the data network 120 using the methods described above with reference to FIGS. 2 and 3. The traffic information hub 502 interacts with vehicles 402 via the wireless communications network 100 and with traffic control infrastructure 406, which in the illustrated example is implemented using an intersection status and control module 504 and a traffic light status and control module 506.

The intersection status and control module 504 may be connected to the traffic information hub 502 and to pedestrian sensors 508 and road condition sensors 510. For example, pedestrian sensors 508 may be provided as suitable sensors (such as motion sensors, UE 106 location sensors etc.) configured to detect the location of pedestrians in or near the intersection. Similarly, road condition sensors 510 may be positioned in the road surface and configured to detect a current status of the road surface, such as dry, wet, ice covered etc.). Other sensors (not shown in FIG. 5) may be provided to detect relevant environmental conditions (such as rain, snow, fog, etc.) or traffic flow conditions (such as light, heavy, freely flowing, congested etc.) or traffic events (such as construction, traffic accident etc.). Based on the data received from the sensors 508 and 510, the intersection status and control module 504 may provide information on the status of the intersection to the traffic information hub 502.

The traffic light status and control module 506 may be configured to control the traffic light(s), and thereby control traffic flow through the intersection. in addition, the traffic light status and control module 506 may also report a status of the traffic light(s) to the traffic information hub 502.

A vehicle location server 512 may be configured to estimate vehicle location based on information available in the core network 114. For example, positioning techniques such as received signal strength differential or time-of-arrival data from base stations 104 can be used to triangulate the vehicle position using known techniques.

A vehicle status and detection server 514 may be configured to accumulate vehicle location and status data based on information provided by each vehicle 402. For example, a vehicle computer 420 may provide location, speed and status (e.g. engine status, detected anomalies or maintenance issues) data to the traffic information hub 502 (for example in response to a status query), which may then store some or all of this information in the vehicle status and detection server 514 for later use, as will be described in greater detail below. In some embodiments, status data indicating a fault or emergency condition in the vehicle may be used to automatically trigger emergency services (such as a towing service, for example) or an incident report that may be used for subsequent maintenance operations.

Representative functions of the above-noted elements are described below:

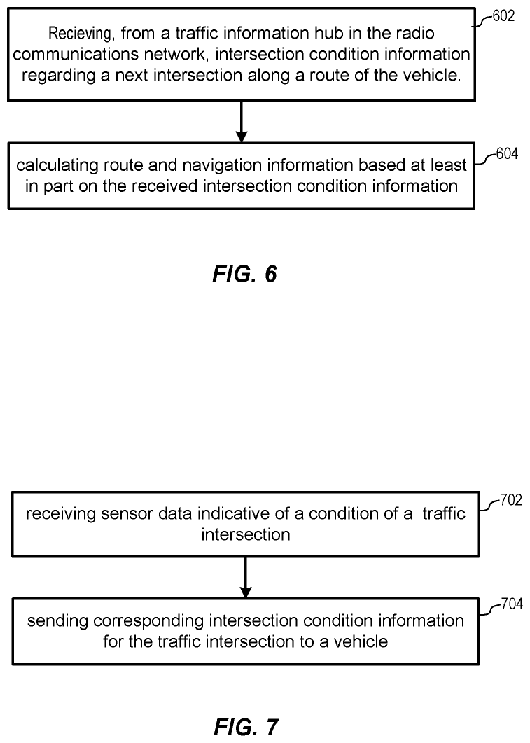

In the vehicle 402:
GPS Receiver 416: Detects the current location and velocity of the vehicle using known methods, and reports this data to the vehicle computer 420;
Vehicle Controller 422: Gathers data from collision avoidance and vehicle status sensors. This may include detection of any object(s) in front of the vehicle, and the operating status of the vehicle.
Cellular Modem 414: Supports wireless communication with one or more Base stations 104 using known Radio Access Technologies (RATs) such as 5G.
Vehicle Computer 420: The Vehicle Computer 420 reports vehicle data to the traffic information hub 502 and/or the vehicle status and detection server 514. This vehicle data may comprise any or all of: vehicle identification, location (obtained by the GPS receiver 416, for example), and vehicle status data including the collision avoidance and vehicle status sensor data (from the vehicle controller 422, for example). In addition, the vehicle status data may also include information identifying a planned route of the vehicle 402. Referring to FIG. 6, the vehicle computer 420 receives (at 602), from the traffic information hub 502, intersection condition information regarding a next intersection along a route of the vehicle 402, and calculates (at 604) route and navigation information based at least in part on the received intersection condition information. The vehicle computer 420 may query the traffic information hub 502 to obtain intersection condition information regarding the next traffic Intersection along its route, and analyse the intersection condition information in conjunction with the vehicle status data to, for example, calculate updated route information, coordinate with other vehicles in the vicinity of the intersection, and safely navigate the intersection even when line of sight from the vehicle 402 is blocked by obstacles, poor weather, or adverse lighting conditions. In an L2/L3 implementation, the vehicle computer 420 may provide navigation recommendations to the driver. In an L4/L5 implementation, the vehicle computer 420 may provide necessary steering and speed control instructions.

In the Network 100:
Vehicle Location Server 512: The Vehicle Location Server 512 may be implemented in the core network 114 using the techniques described above with reference to FIGS. 2 and 3, and may be configured to compute the geographical location of each vehicle 402, for example by means of positioning techniques including received signal strength differential or radio signal time-of-arrival at multiple base stations 104 and triangulation or reported GPS information. The respective geographical location computed for each vehicle 402 may be reported to the traffic information hub 502 and stored in the vehicle status and detection server 514.
Vehicle Status and Detection Server 514: The Vehicle Status and Detection Server 514 may be implemented in the data network 120 using the techniques described above with reference to FIGS. 2-3, and may be configured to function as a repository server storing respective vehicle status information for each vehicle 402. The vehicle status information may comprise vehicle data reported by each vehicle 402, as well as corresponding location information reported by the vehicle location server 512.
Traffic Information Hub 502: The Traffic Information Hub 502 may be implemented in the data network 120 using the techniques described above with reference to FIGS. 2-3, and may be configured to accumulate, maintain and report intersection data relating to each intersection within the system. Referring to FIG. 7, the Traffic Information Hub 502 may receive (at 702) sensor data indicative of a condition of a traffic intersection, and send (at 704) corresponding intersection condition information for the traffic intersection to a vehicle 402. The intersection condition information may include any or all information provided by the traffic control infrastructure 406 including, for example, road surface condition, weather conditions, traffic light status, pedestrian and vehicular traffic status, and traffic information regarding other vehicles. etc. The traffic information may, for example, include any or all of: locations of other vehicles; the respective planned route of each vehicle through the intersection; and network address information of each vehicle, which may be provided to vehicles 402 to enable V2V communication. The low latency of 5G NR enables the intersection information to be delivered to each vehicle 402 in near real-time and with high reliability.

In the Traffic Control Infrastructure 406:
Traffic Light Status and Control 506: The Traffic Light Status and Control 506 may be implemented as a computing device using the techniques described above with reference to FIG. 2, and may be configured to control signaling devices positioned at the intersection, pedestrian crossings, and other locations to control flows of vehicular and pedestrian traffic. It may also report traffic light status data to the traffic information hub 502. The traffic light status data may include fault data which can be used to schedule repair and maintenance operations, as well as indicator state data which may be reported to an approaching vehicle 402 to enable the associated vehicle computer 420 to obtain the current state of the traffic lights (for example, “Inoperative”, “Stop”, “Go”, “Prepared to Stop”, “Caution”) even when line of sight to the lights is obscured by severe weather, poor lighting conditions (e.g. direct sunlight or glare) or other obstructions.
Intersection Status and Control Server 504: The Intersection Status and Control Server 504 may be implemented as a computing device using the techniques described above with reference to FIG. 2, and may be configured to collect and process sensor data to detect potentially hazardous or delay causing conditions on the intersection in real-time. The sensor data and information regarding detected hazardous conditions may be reported to the traffic information hub 502 for use by vehicles 402, for example.

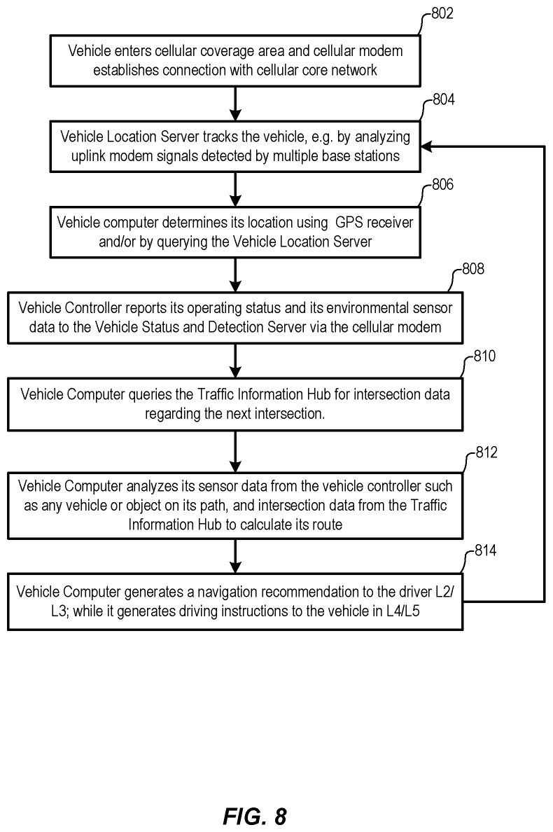

FIG. 8 is a flow chart illustrating elements of an example use case of the present disclosure. Referring to FIG. 8:

Step 1 (at 802): The algorithm starts when the vehicle UE 106 starts to appear in the coverage area of network 100 and the wireless modem 414 connects to the network 100. The UE 106 may, for example, start to appear in the coverage area of network 100 when the vehicle UE 106 starts up (e.g. power “on”), or when the vehicle enters a cell coverage area.

Step 2 (at 804): The core network 114 tracks the location of the vehicle 402 based on signals received from its modem 414 at multiple base stations 104. In some embodiments, and vehicle location server 512 may be configured to compute the vehicle location based on positioning techniques including received signal strength differential or time-of-arrival data received from the base stations 104, as described above. In LTE networks, location calculation may be performed using the LTE Positioning Protocol A (LPPa), for example.

Step 3 (at 806): The vehicle computer 420 determines its location using the GPS receiver 416, either alone or in combination with querying the network 100 (e.g. by querying the vehicle location server 512). This arrangement is beneficial in that the network-computed location information can be used to supplement GPS-based location data for improved accuracy or dual redundancy safety and to ensure continuity of vehicle positioning data when one or other of the network-based and GPS-based location data are not available (e.g. when the vehicle 402 is in a tunnel and GPS satellite signals are blocked; or when the vehicle 402 enters a valley suffered from a reduced network coverage).

Step 4 (at 808): The operating status of the vehicle is analyzed by the vehicle controller 422 and the resulting vehicle status data may be reported as described above.

Step 5 (at 810): The vehicle computer 420 queries the traffic information hub 502 to obtain intersection condition information regarding the upcoming intersection. For example, the vehicle computer 420 may use its current location, its heading direction, planned route and local map information to determine the next upcoming traffic intersection along its planned route, and query the traffic information hub 502 using an identifier of the determined intersection. In an alternative embodiment, the traffic information hub 502 may determine the location of the vehicle 502, for example by querying the Vehicle Location Server 512 using an identifier of the vehicle, and then determine the next traffic intersection. In some embodiments, the location information may comprise one of more identifiers indicative of a road on which the vehicle is located and a direction of travel of the vehicle. In some embodiments, the location information may further comprise either one or both of an identifier of a waypoint associated with the road and a predetermined segment of the road. For example, mapping information for a roadway may include waypoints or road segments that can be identified by the vehicle computer, for example based on GPS data or beacon signals. In some embodiments, the location information may further comprise a distance between the vehicle and the next intersection.

In some embodiments, the vehicle computer 420 may generate one or more status reports, which may be sent (e.g. to the vehicle status and detection server 514) either as part of the query to the traffic information hub 502, or in separate messaging. These status reports may include information and/or indicators of any one or more of: current vehicle speed, current vehicle direction, current vehicle location, local traffic congestion, local road conditions etc. For example, on-board sensors and GPS data may be used to detect the presence of another vehicle directly ahead of the vehicle. This detection result, in combination with a low speed of the vehicle (e.g. a speed slower than a predetermined minimum speed limit for the road on which the vehicle is located) can be used to infer local congestion in the vicinity of the vehicle. If the vehicle is also equipped to detect traffic in adjacent lanes, then the presence of slow-moving traffic in the adjacent lanes can also be used to support an inference of local congestion.

Step 6 (at 812): The vehicle computer 420 analyzes the received intersection condition information, possibly in combination with sensor data from the vehicle controller 422 to calculate route and navigation information. In some embodiments, calculating route and navigation information may include calculating, in response to the received intersection condition information, any one or more of: a route change; a lane change; and a speed change. In some embodiments, calculating a speed change may comprise calculating a speed profile for the vehicle between its current location and the next intersection. For example, the intersection condition information may include an indication of congestion of the next intersection, and in this case calculating the speed profile for the vehicle can include determining a possible speed profile that minimizes (or avoids) the congestion. This possible speed profile can then be accepted as the speed profile for the vehicle, or alternatively adjusted based on other factors (such as predetermined minimum and maximum speed limits) to compute the speed profile for the vehicle.

As may be appreciated, the congestion in any given intersection may be inferred by either the Traffic Information Hub 502 or the Intersection Status and Control 504 based in various ways. For example, the Intersection Status and Control 504 may infer the presence of congestion in a given lane based on sensor data indicating an increasing number of vehicles moving at low speed in that lane. Similarly, the Traffic Information Hub 502 may infer the presence of congestion in a given lane based on an indication from the Intersection Status and Control 504 and/or vehicle status reports including a local congestion indication from one of more vehicles in that particular lane.

In some embodiments, the intersection condition information may comprise an indication of priority vehicle traffic, and in this case calculating the speed profile for the vehicle may include determining a speed profile that minimizes a conflict between the vehicle and the priority vehicle traffic. For example, in an embodiment in which the indication of priority vehicle traffic includes information indicative of an arrival time of the priority vehicle traffic at the next intersection, the step of calculating the speed profile can include determining a possible speed profile such that the vehicle will arrive at the next intersection after the priority vehicle traffic. This possible speed profile can then be accepted as the speed profile for the vehicle, or alternatively adjusted based on other factors (such as predetermined minimum and maximum speed limits) to compute the speed profile for the vehicle.

Step 7 (at 814): The vehicle computer 420 generates an output based on the calculated route and navigation information. In an L2/L3 vehicle, the vehicle computer 420 may generate navigation recommendations for the driver, which may be published through a man-machine-interface. In an L4/L5 autonomous vehicle, the vehicle computer 420 may generate a set of driving instructions for execution by the vehicle 402.

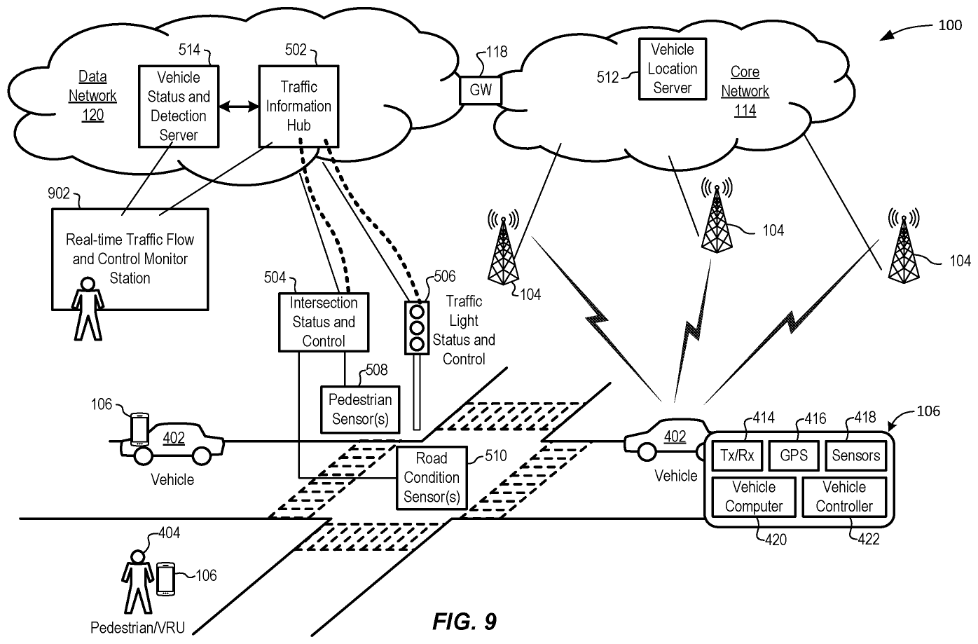

FIG. 9 illustrates an example embodiment in which a real-time traffic flow and control monitoring station 902 receives vehicle status information from the vehicle status and detection server 514, and intersection status information from the traffic information hub 502. The collected data may be utilized to monitor the real-time traffic demand, model the real-time traffic patterns and optimize the traffic control infrastructure 406 (e.g. by adjusting timing of traffic lights) to mitigate bottlenecks and congestion due to traffic volume or blockages such as traffic accidents. The vehicle status and detection server 514 captures the location, speed and direction of each reported vehicle 402, which enables any traffic flow and/or ongoing congestion to be discovered. This input data forms a closed loop feedback control system to optimize the infrastructure equipment such as the timing of a traffic light signal. In addition, an accident or congestion alert can be sent to all subscribed vehicles in a chosen region (e.g. on roadways leading toward the location of the problem).

Historic traffic flow data may reveal patterns of congestion or traffic accidents. Such patterns may change over time (for example due to changing weather patterns throughout the year). For example, traffic patterns during summer may be different than those in the winter. A municipal government may use this data to optimize mitigation plans in accordance with funding budgets.

The embodiment of FIG. 9 describes the use of a closed loop control system with real-time data. Further embodiments and variations will be apparent to those of ordinary skill in the art.

For example, in L4/L5 autonomous vehicles, the destination for any given trip may be entered and the route calculated before the trip begins. The calculated route may include an ordered set of traffic intersections. In some embodiments, the ordered set of intersections may be reported to the traffic information hub 502 and/or stored in the vehicle status and detection server 514. In other embodiments, the ordered set of intersections may be used by the vehicle computer 420 to determine the next intersection along its route, and information identifying that intersection reported to the traffic information hub 502 and/or stored in the vehicle status and detection server 514. In either case, once the vehicle 402 crosses an intersection along its route, the traffic information hub 502 can execute a handover or tracking process including a prediction technique such as Machine Learning to project the next intersection along the route to associate the vehicle 402 with the next intersection, and generate relevant parameters such as, for example, an estimated time of arrival at the next intersection, and a path through the intersection (e.g. straight through, left turn, right turn etc.). This may be used to predict future traffic volumes in a predefined time interval, and/or change traffic light timing to pre-emptively reduce congestion. This enables prediction of the future traffic volume and direction in each traffic intersection.

In the embodiments described above with reference to FIG. 6, the traffic information hub 502 may operate to implement a method including steps of receiving sensor data indicative of a condition of a traffic intersection, and sending corresponding intersection condition information for the traffic intersection to a vehicle.

In some embodiments the sensor data indicative of a condition of a traffic intersection may include sensor data indicative of any one or more of:
a road condition;
a vehicular traffic condition;
a pedestrian traffic condition;
a weather condition; and
a traffic light status.

In some embodiments, the intersection condition information sent to the vehicle may include one or more indicators that are derived from the sensor data, or a combination of sensor data and indicators derived from sensor data. For example, the intersection condition information may include sensor data such as a count of pedestrians in the intersection, and derived indicators such as a road surface condition indicator that is derived from sensor data.

In some embodiments, the traffic information hub 502 may operate to receive sensor data indicative of a condition of plurality of traffic intersections.

In some embodiments, the traffic information hub 502 may operate to receive a query from the vehicle, and send the intersection condition information to the vehicle in response to the query. For example, the query may include an identifier of a selected traffic intersection, and wherein sending the intersection condition information for the selected traffic intersection comprises sending intersection condition information associated with the identifier.

The query may include a current location of the vehicle. In such cases, the traffic information hub 502 may operate to identify a next intersection along a route of the vehicle, based at least in part on the current location of the vehicle, and then send the intersection condition information for the identified next intersection to the vehicle.

In some embodiments the traffic information hub 502 may receive vehicle status information from the vehicle. The vehicle status information may include at least an identifier of the vehicle and sensor data indicative of a status of the vehicle. For example, the sensor data may comprise any one or more of: a current speed of the vehicle; and a current direction of the vehicle.

The vehicle status information received from the vehicle may also include information identifying a current location of the vehicle, for example, based on GPS or beacon signals. This information may be used either in combination with or as an alternative to vehicle location information obtained from the Vehicle Location Server 512.

In some embodiments, the intersection condition information sent to the vehicle may include an indication of congestion of the next intersection. The indication of congestion may be a predicted congestion of the next intersection at an estimated time of arrival of the vehicle at the next intersection. For example, based on the vehicle location and speed, as well as the speed of other traffic approaching and leaving the next intersection, the Traffic Information Hub 502 can estimate the time that the vehicle will most likely enter the intersection. Based on this prediction, and a current congestion trend (i.e. increasing, constant, decreasing etc.) the Traffic Information Hub 502 can predict the congestion that will be present in the intersection at the estimated time of arrival of the vehicle.

In some embodiments the traffic information hub 502 may be configured to control the traffic control infrastructure 406 associated with the next intersection to mitigate the congestion. For example, the traffic control infrastructure 406 can be controlled to adjust a timing of the traffic control lights 408 to reduce a number of cars waiting in a turning lave, for example.

In some embodiments, the query received from the vehicle may include an indication of a priority of the vehicle, and the traffic information hub 502 may be configured to control the traffic control infrastructure 406 associated with the next intersection to provide priority access to the vehicle based on the indication of priority of the vehicle. For example, the query may include an identifier to indicate that the vehicle is an emergency services vehicle (such as police, ambulance or fire vehicle). In response to the identifier, the traffic information hub 502 can control the traffic control infrastructure 406 to allow traffic ahead of the emergency vehicle (e.g. travelling in the same direction as the emergency vehicle) to clear the intersection, whilst blocking traffic trying cross the intersection in front of the emergency vehicle. In some embodiments, the traffic information hub 502 may be further configured to send an instruction to another vehicle to adjust either one or both of its route and speed to minimize conflict with the vehicle. For example, the traffic information hub 502 may send an instruction to the other vehicle to reduce its speed such that it will arrive at the intersection after the emergency vehicle.

While processes in the figures may show a particular order of operations performed by certain embodiments of the present disclosure, it should be understood that such order is representative, and that alternative embodiments may perform the operations in a different order, combine certain operations, overlap certain operations, etc.

Those skilled in the art will recognize improvements and modifications to the embodiments of the present disclosure. All such improvements and modifications are considered within the scope of the concepts disclosed herein.

Based on the foregoing, specific embodiments may comprise any one or more of the following:

Embodiment 1. A vehicle computer for use in a vehicle, the vehicle computer comprising:
at least one processor;
an interface to a radio communications network; and
a memory including software instructions configured to control the at least one processor to implement a method comprising steps of:
   receiving, from a traffic information hub in the radio communications network, intersection condition information regarding a next intersection along a route of the vehicle; and
   calculating route and navigation information based at least in part on the received intersection condition information.

Embodiment 2: The vehicle computer as defined in Embodiment 1, wherein the intersection condition information comprises information indicative of any one or more of:
a road condition;
a vehicular traffic condition;
a pedestrian traffic condition;
a weather condition; and
a traffic light status.

Embodiment 3: The vehicle computer as defined in Embodiment 1, further comprising sending a query to the traffic information hub, the query identifying at least the next intersection along the route of the vehicle, the intersection condition information being received after sending the query.

Embodiment 4: The vehicle computer as defined in Embodiment 1, further comprising reporting vehicle status information to the traffic information hub, the vehicle status information including at least an identifier of the vehicle and sensor data indicative of a status of the vehicle.

Embodiment 5: The vehicle computer as defined in Embodiment 1, further comprising reporting vehicle status information to a vehicle status and detection server in the wireless communications network, the vehicle status information including at least an identifier of the vehicle and sensor data indicative of a status of the vehicle.

Embodiment 6: The vehicle computer as defined in Embodiment 4 or Embodiment 5, wherein the vehicle status information further includes location information identifying a current location of the vehicle.

Embodiment 7: The vehicle computer as defined in Embodiment 6, wherein the route and navigation information is calculated based on both the received intersection condition information and the vehicle status information.

Embodiment 8: A traffic information hub comprising:
at least one processor;
an interface to a data network; and
a memory including software instructions configured to control the at least one processor to implement a method comprising steps of:
   receiving intersection condition information for each one of a plurality of traffic intersections;
   receiving a query from a vehicle; and
   responsive to the query, sending intersection condition information for a selected traffic intersection to the vehicle.

Embodiment 9: The traffic information hub as defined in Embodiment 8, wherein the query includes an identifier of the selected traffic intersection, and wherein sending the intersection condition information for the selected traffic intersection comprises sending intersection condition information associated with the identifier.

Embodiment 10: The traffic information hub as defined in Embodiment 8, wherein the query includes a current location of the vehicle, and wherein sending the intersection condition information for the selected traffic intersection comprises:
identifying a next intersection along a route of the vehicle, based at least in part on the current location of the vehicle; and
sending the intersection condition information for the identified next intersection.

1. A method in a vehicle computer for use in a vehicle, the method comprising:
receiving, from a traffic information hub in a radio communications network, intersection condition information regarding a next intersection along a route of the vehicle; and
calculating route and navigation information based at least in part on the received intersection condition information.

2. (canceled)

3. The method as claimed in claim 1, further comprising sending a query to the traffic information hub, the query identifying at least the next intersection along the route of the vehicle, the intersection condition information being received after sending the query.

4. The method as claimed in claim 1, further comprising reporting vehicle status information to the traffic information hub or reporting vehicle status information to a vehicle status and detection server in the wireless communications network, the vehicle status information including at least an identifier of the vehicle and sensor data indicative of a status of the vehicle.

5-6. (canceled)

7. The method as claimed in claim 3, wherein the vehicle status information further includes location information identifying a current location of the vehicle.

8. The method as claimed in claim 4, wherein the location information comprises one of more identifiers indicative of a road on which the vehicle is located and a direction of travel of the vehicle.

9. The method as claimed in claim 4, wherein the location information further comprises either one or both of an identifier of a waypoint associated with the road and a predetermined segment of the road.

10-11. (canceled)

12. The method as claimed in claim 4, wherein the vehicle status information further comprises an indication of a priority of the vehicle.

13. The method as claimed in claim 1, wherein calculating route and navigation information comprises calculating, in response to the received intersection condition information, any one or more of: a route change; a lane change; and a speed change.

14. The method as claimed in claim 13, wherein calculating a speed change comprises calculating a speed profile for the vehicle between a current location of the vehicle and the next intersection.

15. The method as claimed in claim 14, wherein the intersection condition information comprises an indication of congestion of the next intersection, and wherein calculating the speed profile for the vehicle comprises determining a speed profile that minimizes the congestion.

16. The method as claimed in claim 14, wherein the intersection condition information comprises an indication of priority vehicle traffic, and wherein calculating the speed profile for the vehicle comprises determining a speed profile that minimizes a conflict between the vehicle and the priority vehicle traffic.

17. The method as claimed in claim 16, wherein the. indication of priority vehicle traffic comprises information indicative of an arrival time of the priority vehicle traffic at the next intersection, and wherein determining a speed profile that minimizes a conflict between the vehicle and the priority vehicle traffic comprises determining the speed profile such that the vehicle will arrive at the next intersection after the priority vehicle traffic.

18. A vehicle computer for use in a vehicle, the vehicle computer comprising:
at least one processor;
an interface to a radio communications network; and
a memory including software instructions configured to control the at least one processor to:
receive, from a traffic information hub in a radio communications network, intersection condition information regarding a next intersection along a route of the vehicle; and
calculate route and navigation information based at least in part on the received intersection condition information.

19. A method in a network node, the method comprising:
receiving sensor data indicative of a condition of a traffic intersection; and
sending corresponding intersection condition information for the traffic intersection to a vehicle.

20-21. (canceled)

22. The method as claimed in claim 19, further comprising receiving respective sensor data indicative of a condition of a plurality of traffic intersections.

23. The method as claimed in claim 22, further comprising receiving a query from the vehicle, the intersection condition information being sent to the vehicle responsive to the query.

24. The method as claimed in claim 23, wherein the query includes an identifier of a selected traffic intersection, and wherein sending the intersection condition information for the selected traffic intersection comprises sending intersection condition information associated with the identifier.

25. The method as claimed in claim 24, wherein the query includes a current location of the vehicle, and wherein sending the intersection condition information for the selected traffic intersection comprises:
identifying a next intersection along a route of the vehicle, based at least in part on the current location of the vehicle; and
sending the intersection condition information for the identified next intersection.

26-28. (canceled)

29. The method as claimed in claim 25, wherein the intersection condition information comprises an indication of congestion of the next intersection; and, wherein the indication of congestion comprises a predicted congestion of the next intersection at an estimated time of arrival of the vehicle at the next intersection.

30. (canceled)

31. The method as claimed in claim 29, further comprising controlling traffic control infrastructure associated with the next intersection to mitigate the congestion.

32. The method as claimed in claim 25, wherein the query includes an indication of a priority of the vehicle, and wherein the method further comprises controlling traffic control infrastructure associated with the next intersection to provide priority access to the vehicle based on the indication of priority of the vehicle.

33. (canceled)

34. A traffic information hub in a radio communications network comprising:
at least one processor;
an interface to the radio communications network; and
a memory including software instructions configured to control the at least one processor to:
receive sensor data indicative of a condition of a traffic intersection; and
send corresponding intersection condition information for the traffic intersection to a vehicle.
